(19) United States
(12) Patent Application Publication
(10) Pub. No.: US 2026/0064050 A1
(43) Pub. Date: Mar. 5, 2026

(54) FIXING DEVICE, IMAGE FORMING APPARATUS AND HEATER POWER CONTROL METHOD

(71) Applicant: KYOCERA Document Solutions Inc., Osaka (JP)

(72) Inventor: Shunsaku FUJII, Osaka (JP)

(73) Assignee: KYOCERA Document Solutions Inc., Osaka (JP)

(21) Appl. No.: 19/298,123

(22) Filed: Aug. 12, 2025

(30) Foreign Application Priority Data
Aug. 27, 2024 (JP) 2024-145432

(51) Int. Cl. G03G 15/20; G03G 15/00

(52) U.S. Cl. CPC G03G 15/2039; G03G 15/2053; G03G 15/2064; G03G 15/5004; G03G 2215/2025

(57) ABSTRACT

A fixing device includes a fixing belt, a pressure member, a heater, a belt temperature detection part, a heater temperature detection part, and a power control part. The power control part executes a first power supply control for supply power to the heater, in a first control cycle until the heater temperature detection part detects a target temperature and the belt temperature detection part detects a temperature outside a target range. When the belt temperature detection part detects a temperature outside the target range, the power control part executes a correction control for correcting the target temperature so that the belt temperature detection part detects a temperature within the target range, and a second power supply control for supplying power to the heater so that the heater temperature detection part detects a corrected target temperature, in a second control cycle 10 times or more the first control cycle.

### INCORPORATION BY REFERENCE

This application is based on and claims the benefit of priority from Japanese patent application No.2024-145432 Aug. 27, 2024, which is incorporated by reference in its entirety.

### TECHNICAL FIELD

The present disclosure relates to a fixing device which fixes a toner image on a medium, an image forming apparatus, and a heater power control method.

### BACKGROUND

An electrophotographic image forming apparatuses is provided with a fixing device for fixing a toner image on a paper. The fixing device may include a fixing belt heated by a resistance heating element, a pressure member forming a nip region between the fixing belt and the pressure member, a temperature detection means for detecting a temperature of the fixing belt, and a position detection means for detecting a circumferential position of the fixing belt. The fixing device has a characteristic memory mode in which power is supplied to the resistance heating element during non-fixing operation and the temperature related to the circumferential position of the fixing belt is stored, and a fixing execution mode in which the power supplied to the resistance heating element is corrected from the stored position and temperature during fixing operation to control a temperature of the nip region to the target temperature.

In the fixing device described above, the resistance heating element generates heat by the supplied electric power, and the fixing belt is heated by receiving the heat from the resistance heating element. That is, the temperature of the fixing belt begins to rise after the temperature of the resistance heating element. In the above fixing device, since the power supplied to the resistance heating element is controlled based on the temperature of the fixing belt, there is a possibility that the resistance heating element is excessively heated when the temperature of the nip region (the fixing belt) reaches the target temperature. Therefore, there is problems that the resistance heating element itself and its surrounding parts (sensors or the like) break down under a high-temperature environment.

In addition, when the power supplied to the resistance heating element is controlled based on the temperature of the fixing belt, the following problems also exist. For example, even if the power supply to the resistance heating element is stopped when the temperature of the nip region (the fixing belt) exceeds the target temperature, since the fixing belt continues to receive the heat from the excessively heated resistance heating element, the temperature of the fixing belt will continue to rise. Furthermore, since the resistance heating elements disposed inside the fixing belt are harder to be cooled than the fixing belt, if the power supply to the resistance heating elements is started when the temperature of the nip region falls below the target temperature, the resistance heating elements that is not cooled sufficiently may again become excessively heated. Then, the temperature of the nip part becomes unstable, and proper fixing cannot be performed, resulting in problems such as a decrease in image quality of the fixed image.

### SUMMARY

A fixing device according to the present disclosure includes a fixing belt, a pressure member, a heater, a belt temperature detection part, a heater temperature detection part, and a power control part. The fixing belt is in a cylindrical shape and heats toner on a medium while rotating around an axis. The pressure member forms a pressure region between the fixing belt and the pressure member, and pressurizes the toner on the medium passing through the pressure region while rotating around an axis. The heater comes into contact with an inner surface of the fixing belt facing the pressure region, receives electric power, generates heat, and heats the fixing belt. The belt temperature detection part detects a temperature of the fixing belt. The heater temperature detection part detects a temperature of the heater. The power control part controls power supplied to the heater. The power control part executes a first power supply control for supply power to the heater, in a first control cycle until the heater temperature detection part detects a target temperature and the belt temperature detection part detects a temperature outside a target range. When the belt temperature detection part detects a temperature outside the target range, the power control part executes a correction control for correcting the target temperature so that the belt temperature detection part detects a temperature within the target range, and a second power supply control for supplying power to the heater so that the heater temperature detection part detects a corrected target temperature, in a second control cycle set at a time interval 10 times or more the first control cycle.

An image forming apparatus according to the present disclosure includes the fixing device.

A method for controlling power of a heater provided in the fixing device includes a power supply process and a correction power supply process. The power supply process executes the first power supply control for supplying power to the heater in the first control cycle until the heater temperature detection part detects the target temperature and the belt temperature detection part detects a temperature outside the target range. The correction power supply process executes the correction control and the second power supply control in the second control cycle. The correction control corrects the target temperature so that the belt temperature detection part detects a temperature within the target range when the belt temperature detection part detects a temperature outside the target range. The second power supply control supplies power to the heater so that the heater temperature detection part detects the corrected target temperature.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a schematic diagram (side view) showing an internal structure of an image forming apparatus according to one embodiment of the present disclosure.

FIG. 2 is a perspective view showing a fixing device according to the embodiment of the present disclosure.

FIG. 3 is a cross-sectional view taken along the line III-III of FIG. 2.

FIG. 4 is a bottom view showing a heater of the fixing device according to the embodiment of the present disclosure.

FIG. 5 is a block diagram showing a relationship between each detection part and a control device of the fixing device according to the embodiment of the present disclosure.

FIG. 6 is a flowchart showing a power control method of the heater according to the embodiment of the present disclosure.

FIG. 7 is a graph showing the results of the test (1) of the power control method of the heater according to the embodiment of the present disclosure, which shows temporal changes in a heater temperature and a power.

FIG. 8 is a graph showing the results of the test (2) of the power control method of the heater according to the embodiment of the present disclosure, which shows temporal changes in a heater temperature and a power.

FIG. 9 is a graph showing the results of the comparative test, which shows temporal changes in a heater temperature and a power.

### DETAILED DESCRIPTION

Hereinafter, with reference to the attached drawings, an embodiment of the present disclosure will be described. Fr, Rr, L, R, U and D shown in the drawings indicate front, rear, left, right, upper and lower. The front-and-rear direction, the left-and-right direction (axial direction), and the upper-and-lower direction are orthogonal to each other. Although terms indicating direction and position are used herein, these terms are used for convenience of explanation and are not intended to limit the scope of the disclosure. In each of the figures, the dimensions and angles of the members are not accurate and are schematized for the sake of illustration.

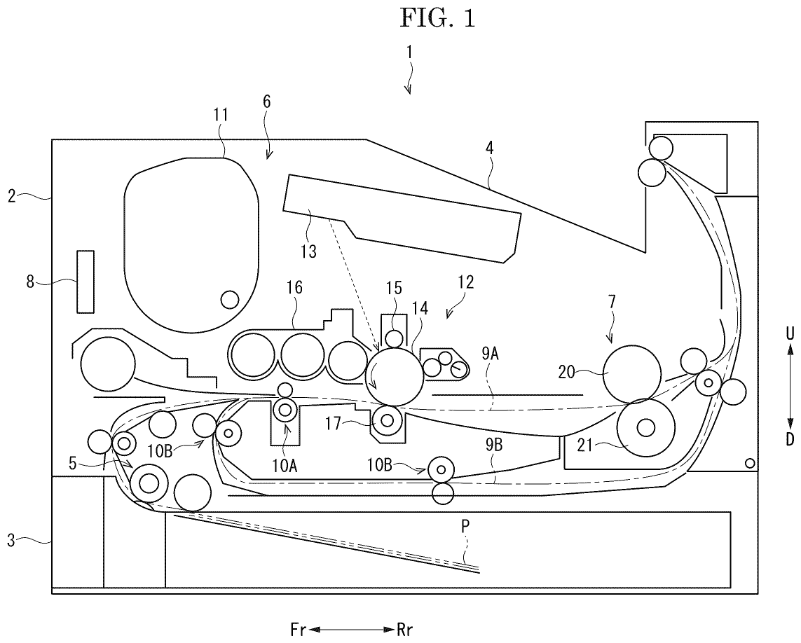

With reference to FIG. 1, an image forming apparatus 1 according to the present embodiment will be described. FIG. 1 is a schematic view (side view) showing the image forming apparatus 1.

The image forming apparatus 1 is an electrophotographic printer. The image forming apparatus 1 includes with an apparatus main body 2 constituting a substantially rectangular parallelepiped appearance. A paper feeding cassette 3 which stored a paper P (medium), for example, is detachably provided at the lower portion of the apparatus main body 2. A paper discharge tray 4 is provided on the upper surface of the apparatus main body 2. The paper P as an example of the medium is not limited to a paper but may be a resin sheet or the like. The terms “upstream”, “downstream”, and the related terms refer to “upstream”, “downstream” in the conveyance direction of the paper P (medium), and the related concepts.

The image forming apparatus 1 includes a paper feeding device 5, an image forming device 6, and a fixing device 7. The paper feeding device 5 is provided at the upstream end of a conveyance path 9A extending from the paper feeding cassette 3 to the paper discharge tray 4, and feeds the papers P stored in the paper feeding cassette 3 to the conveyance path 9A one by one. The image forming device 6 is provided in the intermediate portion of the conveyance path 9A and forms a toner image on the conveyed paper P. The fixing device 7 is provided on the downstream portion of the conveyance path 9A and thermally fixes the toner image to the paper P.

On the conveyance path 9A, a pair of registration rollers 10 which temporarily blocks the conveyed paper P and corrects the skew of the paper P (skew correction) is provided. An inversion conveyance path 9B is provided below the conveyance path 9A, which branches at the downstream portion of the conveyance path 9A and merges with the upstream portion of the conveyance path 9A. On the inversion conveyance path 9B, a plurality of pairs of conveying rollers 10B for conveying the paper P are provided.

The image forming device 6 includes a toner container 11, a drum unit 12, and an optical scanner 13. The toner container 11 is disposed in the front upper portion of the apparatus main body 2, and contains, for example, black toner (developer). The drum unit 12 includes a photosensitive drum 14, a charging device 15, a developing device 16, and a transfer roller 17. The photosensitive drum 14 is formed in a substantially cylindrical shape, and is driven to be rotated around an axis by a motor (not shown). The charging device 15, the developing device 16 and the transfer roller 17 are arranged around the photosensitive drum 14 in the order of the image forming process. The transfer roller 17 is in contact with the photosensitive drum 14 from the lower side to form a transfer nip. The optical scanner 13 is provided above the photosensitive drum 14, and emits scanning light toward the surface of the photosensitive drum 14.

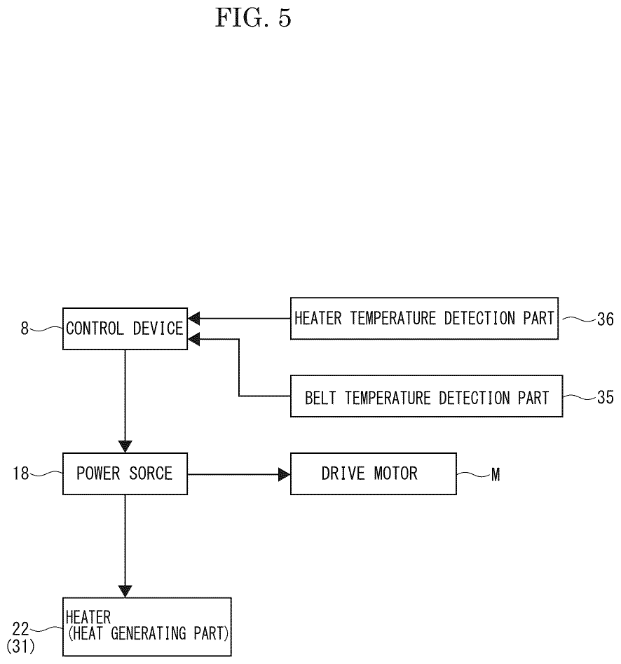

The image forming apparatus 1 is provided with a control device 8 for controlling the entire apparatus. The control device 8 includes a memory, a processor, and the like (not shown). The processor reads programs and data stored in the memory and performs arithmetic operations. The control device 8 is electrically connected to each device or the like constituting the image forming apparatus 1 via an interface unit (not shown), and controls various processes related to image formation. Further, the control device 8 is electrically connected to a power source 18 for supplying power to each device (see FIG. 5 described later), and controls the power supply to the devices. The control device 8 may be formed of a logic circuit (hardware) formed in an integrated circuit or the like.

### Image Forming Process

The control device 8 for controlling the image forming apparatus 1 performs an image forming process based on image data input from an external terminal as follows.

The charging device 15 charges the surface of the photosensitive drum 14, and the optical scanner 13 emits scanning light based on the image data to form an electrostatic latent image on the photosensitive drum 14. The developing device 16 develops the electrostatic latent image on the photosensitive drum 14 into a toner image using the toner replenished from the toner container 11. The paper feeding device 5 feeds the paper P one by one from the paper feeding cassette 3 to the conveyance path 9A. The paper P is conveyed along the conveyance path 9A, after the skew is corrected by the pair of registration rollers 10A, the paper P enters the transfer nip. The transfer roller 17 transfers the toner image on the photosensitive drum 14 to the surface of the paper P passing through the transfer nip. The fixing device 7 thermally fixes the toner image to the paper P. In the case of single-sided printing, the paper P which has passed through the fixing device 7 is discharged to the paper discharge tray 4.

In the case of double-sided printing, the paper P which has passed through the fixing device 7 is switched back at the downstream end of the conveyance path 9A, and sent to the inversion conveyance path 9B. The paper P is conveyed by the pair of conveying rollers 10B, returned from the inversion conveyance path 9B to the conveyance path 9A again, and sent to the transfer nip after the skew correction by the pair of registration rollers 10A. Thereafter, the toner image is transferred to the paper P, and thermally fixed, and the double-sided printed paper P is discharged to the paper discharge tray 4.

### Fixing Device

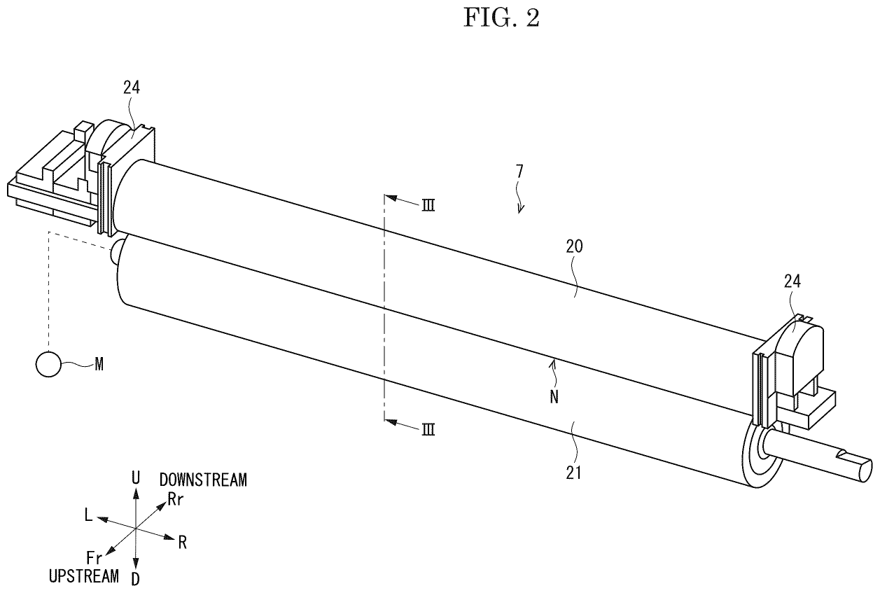

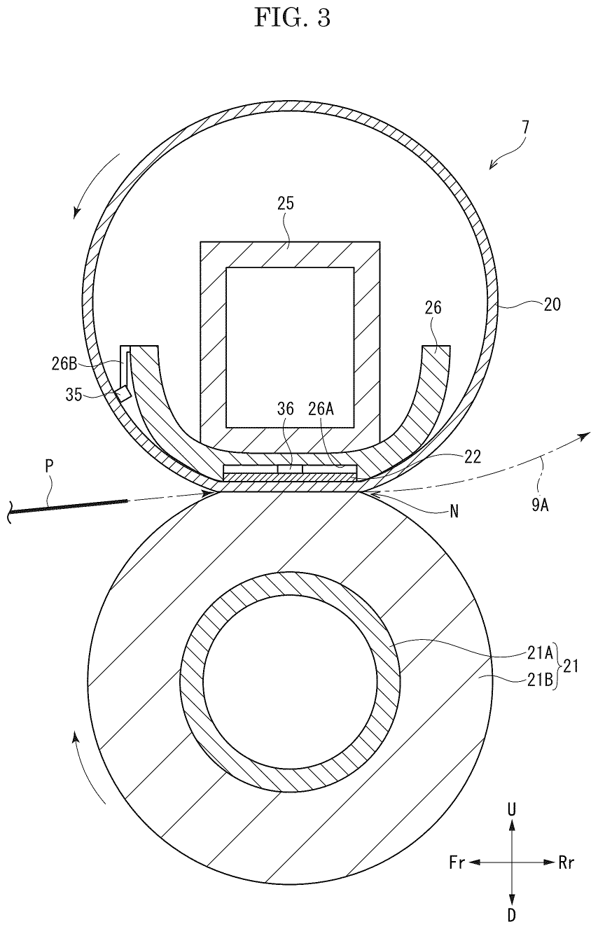

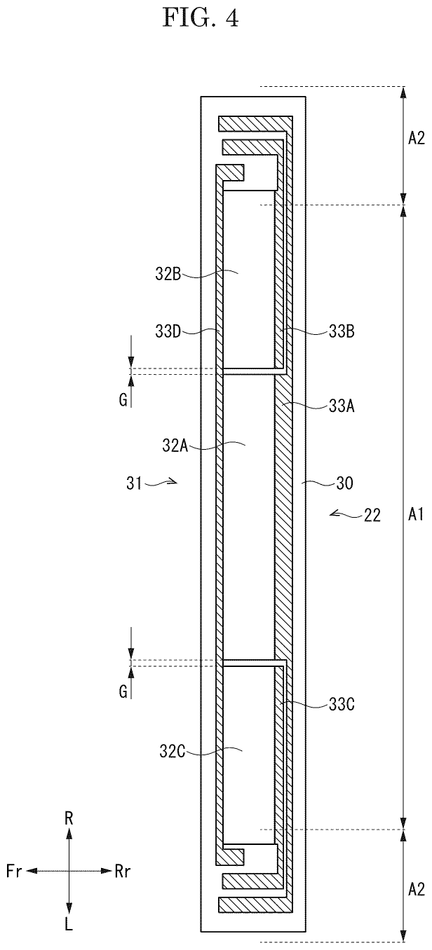

Next, with reference to FIG. 2 to FIG. 4, the fixing device 7 will is described. FIG. 2 is a perspective view showing the fixing device 7. FIG. 3 is a cross-sectional view taken along the line III-III of FIG. 2. FIG. 4 is a bottom view showing a heater 22. FIG. 5 is a block diagram showing the relationship between detection part 35, 36 of the fixing device 7 and the control device 8.

As shown in FIG. 2 and FIG. 3, the fixing device 7 includes a fixing belt 20, a pressure roller 21, a heater 22, a belt temperature detection part 35, and a heater temperature detection part 36. The fixing belt 20 and the pressure roller 21 are supported by a frame (not shown), and the frame is fixed to the apparatus main body 2.

### <Fixing Belt>

The fixing belt 20 is an endless belt formed in a substantially cylindrical shape elongated in the left-and-right direction (axial direction). The fixing belt 20 is made of material having heat resistance and flexibility (polymer resin or metal, or combination of polymer resin and metal). A pair of holding members 24 (see FIG. 2) are inserted into both right and left ends of the fixing belt 20. The pair of holding members 24 guide the fixing belt 20 rotatably around an axis while holding the fixing belt in a substantially cylindrical shape. The fixing belt 20 is supported by the frame via the pair of holding members 24 (not shown).

As shown in FIG. 3, an erection member 25 and a support member 26 are provided in a space surrounded by the fixing belt 20. The erection member 25 is made of, for example, metallic material such as stainless steel, and formed in a substantially rectangular cylindrical shape elongated in the left-and-right direction (axial direction), and is erected between the pair of holding members 24. The support member 26 is fixed to the lower portion of the erection member 25. The support member 26 is made, for example, of synthetic resin having heat resistance and wear resistance, and formed in a substantially semi-cylindrical shape elongated in the left-and-right direction. The support member 26 is curved along the inner surface of the fixing belt 20 and is in contact with the lower portion (the portion on the side of a pressure region N) of the inner surface of the fixing belt 20. A fitting portion 26A into which the heater 22 is fitted is recessed in the lower portion of the support member 26.

### <Pressure Roller>

As shown in FIG. 2 and FIG. 3, the pressure roller 21 as an example of the pressure member is formed in a substantially cylindrical shape elongated in the left-and-right direction. The pressure roller 21 has a metal core 21A and an elastic layer 21B such as a silicon sponge laminated on the outer peripheral surface of the metal core 21A (see FIG. 3). A drive motor M is connected to the left end of the metal core 21A via a gear train (not shown) (see FIG. 2). The pressure roller 21 comes into contact with the fixing belt 20 from the lower side and forms a pressure region N between the fixing belt 20 and the pressure roller 21. When the paper P passes through the pressure region N, the toner image is fixed on the paper P. The pressure region N refers to from an upstream position where the pressure is 0 Pa to a downstream position where the pressure is 0 Pa again via a position where the pressure acts.

The paper P is conveyed so that the center of the width in the left-and-right direction substantially coincides with the center of the pressure region N in the left-and-right direction (axial direction). For this reason, the fixing belt 20 (or the pressure region N) is provided with a passing region A1 which is the central region in the axial direction and is in contact with the paper P, and non-passing regions A2 which are the side end regions in the axial direction and are not in contact with the paper P (see FIG. 4). The paper P to be conveyed always comes into contact with the vicinity of the center region in the axial direction of the passing region A1, regardless of the size (dimension in the left-and-right direction) of the paper P. On the other hand, the paper P of a normal size (for example, A4 size) comes into contact with the regions on both sides of the passing region A1 in the axial direction, but the paper P of a small size (for example, A5 size, B5 size, or others) does not come into contact with the regions on both sides of the passing region.

### <Heater>

As shown in FIG. 3, the heater 22 is fitted into the fitting portion 26A of the support member 26. The heater 22 is in contact with the inner surface of the fixing belt 20 facing the pressure region N, generates heat by receiving power supply (from a power source) to heats the fixing belt 20. As shown in FIG. 4, the heater 22 has a substrate 30 and a heat generating part 31.

The substrate 30 is made of, for example, insulator (electrical insulating material) such as ceramic, and is formed in a substantially rectangular plate shape elongated in the left-and-right direction (axial direction). The axial dimension of the substrate 30 (the heater 22) is longer than the axial dimension of the fixing belt 20. The heat generating part 31 is provided on the lower surface (one surface) of the substrate 30 facing the pressure region N across the fixing belt 20. The heat generating part 31 includes three resistance heating elements 32A to 32C arranged in a line with gaps G in the axial direction. In this specification, in the description common to the three resistance heating elements 32A to 32C, only arithmetic numerals are attached to the reference numerals. The gap G is set to an insulation distance (creepage distance) capable of preventing creeping discharge between the adjacent resistance heating elements 32.

The resistance heating element 32 is made of metal material having a high electrical resistance value, and formed in a substantially rectangular shape. The entire heat generating part 31 is shorter than the total length of the fixing belt 20 in the left-and-right direction (axial direction) and longer in the axial direction than the passing region A1 of the fixing belt 20. That is, both axial sides of the resistance heating elements 32B, 32C, which are located on both sides of the axial direction, face the non-passing regions A2 of the fixing belt 20. The resistance heating elements 32A located in the center of the axial direction correspond to the width of the small size paper P in the left-and-right direction, and all resistance heating elements 32A to 32C correspond to the width of the normal size paper P in the left-and-right direction.

On the lower surface of the substrate 30, three individual electrodes 33A to 33C and a common electrode 33D are formed. The three individual electrodes 33A to 33C and the common electrode 33D are made of, for example, metal material having an electrical resistance lower than that of the resistance heating element 32. In the present specification, when the three individual electrodes 33A to 33C and the common electrode 33D are commonly described, only arithmetic numerals are attached to the reference numerals.

The individual electrode 33A is connected to the downstream end (rear end) of the first resistance heating element 32A which is located at the center in the axial direction. The other individual electrodes 33B, 33C are connected to the downstream ends of the resistance heating elements 32B, 32C. The common electrode 333D is connected to the upstream ends (front ends) of all the resistance heating elements 32A to 32C. The electrodes 33 extend toward both sides in the axial direction of the heat generating part 31 from portions connected to the heat generating part 31, respectively. The heat generating part 31 is electrically connected to a power source on both sides of the substrate 30 in the axial direction through the electrode portions 33 (see FIG. 5). Although not shown in the figure, the heater 22 may be connected to the power source 18 via a power interrupting device that interrupts power supply in the event of abnormal heat generation.

The heat generating part 31 and the electrode portion 33 are covered with a coating layer (not shown). The heater 22 is fitted into the fitting portion 26A of the support member 26 and brings the coating layer into contact with the inner surface of the fixing belt 20. When the heater 22 receives the fixing belt 20 pressed against the pressure roller 21, the pressure region N is formed at a contact portion between the fixing belt 20 and the pressure roller 21. In order to make the temperature of the heater 22 and the fixing belt 20 uniform over the axial direction and to suppress excessive heating up of the non-passing regions A2, for example, a metal heat equalizing member may be in contact with the upper surface of the substrate 30 (not shown).

### <Belt Temperature Detection Part, Heater Temperature Detection Part>

As shown in FIG. 3, the belt temperature detection part 35 is attached to the lower end of a suspension member 26B, which extends downward from the front upper end of the support member 26 in the inner space of the fixing belt 20. The belt temperature detection part 35 is a temperature sensor, such as a thermistor, for example, which is in contact with the inner surface of the fixing belt 20 on the upstream side of the pressure region N and detects the temperature of the fixing belt 20. The heater temperature detection part 36 is fixedly attached to the upper surface of the fitting portion 26A of the support member 26 and is provided between the heater 22 and the support member 26. The heater temperature detection part 36 is a temperature sensor, such as a thermistor, for example, which is in contact with the upper surface of the substrate 30 of the heater 22 and detects the temperature of the heater 22. The belt temperature detection part 35 and the heater temperature detection part 36 are provided near the center of the axial direction (the passing region area A1), but may be provided on either side of the axial direction (the non-passing regions A2) instead of/in addition to the passing region A1 (not shown).

As shown in FIG. 5, the belt temperature detection part 35 and the heater temperature detection part 36 are electrically connected to the control device 8 via an A/D conversion (Analog to Digital Conversion) circuit or the like (not shown), respectively. The belt temperature detection part 35 and the heater temperature detection part 36 each transmit detection results (detection signals) to the control device 8. The control device 8 receives the detection signals from both detection parts 35, 36 at time intervals of several milliseconds to several tens of milliseconds (sampling rate), for example.

The power source 18 is, for example, a DC stabilized power source which supplies power to the control device 8, the drive motor M, the heater 22, and other devices forming the image forming apparatus 1 (not shown). The power source 18 is a component of the image forming apparatus 1, but may also be considered as a component of the fixing device 7. A dedicated power source which supplies power to the fixing device 7 (the heater 22) may be provided separately from the power source 18 of the image forming apparatus 1 (not shown).

The control device 8 also includes a function as a power control part which controls the power supplied to the heater 22. The control device 8 is a component of the image forming apparatus 1, but may also be considered as a component of the fixing device 7. A dedicated power control part which controls the power supplied to the heater 22 may be provided separately from the control device 8 of the image forming apparatus 1 (not shown).

### Fixing Process

An operation (fixing process) of the fixing device 7 will be described here. The control device 8 drives and controls the drive motor M to rotate the pressure roller 21 around the axis. The fixing belt 20 rotates following the pressure roller 21 (see the arrow in FIG. 3). The control device 8 controls the power source 18 based on the detection signals from the heater temperature detection part 36 and the belt temperature detection part 35 (details will be described below). The heater 22 (the heat generating part 31) generates heat by the electric power supplied from power source 18 to heat fixing belt 20 (the pressure region N).

At this time, the control device 8 changes the resistance heating elements 32 for heating (being powered) according to a size of the paper P. For example, when the paper P of a normal size passes through the pressure region N, the control device 8 executes control for heating all the resistance heating elements 32. When the paper P of a small size passes through the pressure region N, the control device 8 executes control for heating the center resistance heating element 32A. Thus, only a necessary area of the fixing belt 20 (pressure region N) can be heated in accordance with the size of the paper P. As a result, the power used can be kept to a minimum. It is also possible to suppress excessive temperature rise at both the axial end portions of the fixing belt 20.

When the temperature of the fixing belt 20 (the heater 22) reaches the predetermined temperature, the control device 8 starts the image forming process already described. The paper P onto which the toner image has been transferred enters the pressure region N. The fixing belt 20 heats the toner (toner image) on the paper P passing through the pressure region N while rotating around the axis. The pressure roller 21 pressurizes the toner on the paper P which passes through the pressure region N while rotating around the axis. The toner image is then fixed on the paper P, and a fixed image is formed on the paper P. The paper P having the fixed image is then discharged to the paper discharge tray 4.

By the way, in order to perform the proper fixing process, it is required to maintain the fixing belt 20 at the predetermined temperature. In the fixing device 7, since the heater 22 generates heat and heats the fixing belt 20 by transferring the heat to the fixing belt 20, the temperature of the fixing belt 20 begins to rise after the temperature of the heater 22 rises. That is, there is a gap (time lag) between the timing when the heater 22 begins to heat up and the timing when fixing belt 20 begins to heat up. Considering this fact, the heater 22 may generate excessive heat when the temperature of the fixing belt 20 reaches the predetermined temperature. Even if the power supply to the heater 22 is stopped when the temperature of the fixing belt 20 exceeds the predetermined temperature, the temperature of the fixing belt 20 will continue to rise because the fixing belt 20 will continue to receive the heat from the heater 22 which has been excessively heated. In addition, since the heater 22 located inside the fixing belt 20 is harder to be cooled down than the fixing belt 20, if the power supply to the heater 22 is started when the temperature of the fixing belt 20 falls below the predetermined temperature, the heater 22 which has not cooled down sufficiently may again become excessively heated. Therefore, in the fixing device 7 of this embodiment, the control device 8 (the power control part) executes the control (the power control method) to maintain the temperatures of the heater 22 and the fixing belt 20 at the predetermined temperatures.

### Power Control Method

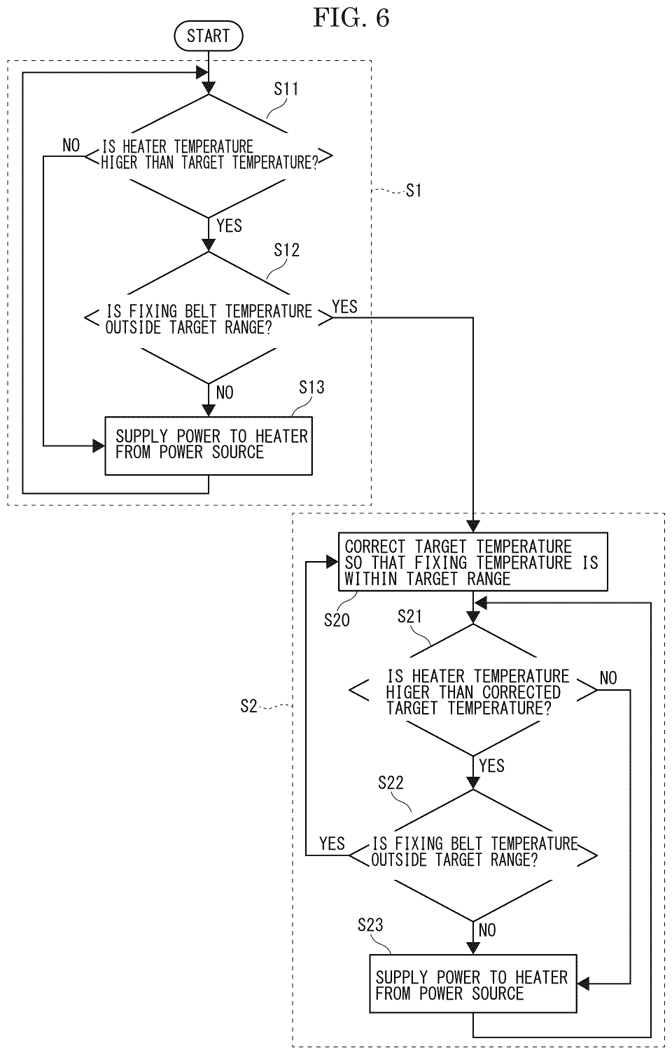

With reference to FIG. 6, the power control method of the heater 22 provided in the fixing device 7 of this embodiment will be described. FIG. 6 is a flowchart showing the power control method of the heater 22.

When the control device 8 receives an instruction to start executing the image forming process (fixing process), it controls an input power (supplied power) to the heater 22 as explained below. The power control method for the heater 22 contains a power supply process S1 and a correction power supply process S2.

### <Power Supply Process>

In the power supply process S1, the control device 8 executes a first power supply control in a first control cycle (T1). In the first power supply control, the power is supplied to the heater 22 until the heater temperature detection part 36 detects the target temperature (tC) and the belt temperature detection part 35 detects the temperature outside the target range (tR). The target temperature (tC) is, for example, the temperature at which the fixing belt 20 can be heated to the temperature required for the fixing process and also the temperature below the heat resistance temperature of the heater 22 and its surrounding components (the heater temperature detection part 36, or the others). The target range (tR) (of the temperature) is the range (upper and lower limits) of the temperature of the fixing belt 20 at which the proper fixing process can be performed. The first control cycle (t1) is the time interval (cycle) at which the power input to the heater 22 is monitored. The target temperature (tC), the target range (tR) and the first control cycle (T1) are obtained experimentally and stored in the memory of the control device 8 in advance.

The power supply process S1 includes a first heater temperature determination process S11, a first belt temperature determination process S12, and a first heater heating process S13.

In the first heater temperature determination process S11, the control device 8 compares the detection signal (the temperature of the heater 22) transmitted from the heater temperature detection part 36 with the target temperature (tC) (for example, 200 degrees Celsius). If the temperature of the heater 22 is less than the target temperature (tC) (NO in S11), the control device 8 executes the first heater heating process S13 for supplying the power to the heater 22 while controlling the power source 18. On the other hand, if the temperature of the heater 22 is equal to or higher than the target temperature (tC) (YES in S11), the control device 8 executes the first belt temperature determination process S12.

In the first belt temperature determination process S12, the control device 8 determines whether the detection signal (the temperature of the fixing belt 20) transmitted from the belt temperature detection part 35 is outside the target range (tR). If the temperature of the fixing belt 20 is within the target range (tR) (equal to or less than the upper limit and equal to or higher than the lower limit) (NO in S12), the control device 8 executes the first heater heating process S13. On the other hand, if the temperature of the fixing belt 20 is outside the target range (tR) (higher than the upper limit or less than the lower limit) (YES in S12), the control device 8 executes the correction power supply process S2 described below.

The first heater temperature determination process S11, the first belt temperature determination process S12, and the first heater heating process S13 (that is, all of the power supply process S1) described above are executed and controlled by the control device 8 to achieve the first power supply control. The control device 8 repeatedly executes the first power supply control (the power supply process S1) in the first control cycle (T1) (for example, 0.1 second intervals).

### <Correction Power Supply Process>

In the correction power supply process S2, the control device 8 executes the correction control and the second power supply control in the second control cycle (T2). The correction power supply process S2 includes a correction process S20, a second heater temperature determination process S21, a second belt temperature determination process S22, and a second heater heating process S23.

In the correction process S20, when the belt temperature detection part 35 detects a temperature outside the target range (tR) (YES in S12), the control device 8 corrects the target temperature (tC) so that the belt temperature detection part 35 detects a temperature within the target range (tR). Specifically, if the belt temperature detection part 35 detects a temperature higher than the target range (tR), the control device 8 sets a value obtained by subtracting the predetermined correction amount (h) from the target temperature (tC) as the corrected target temperature (tC). On the other hand, if the belt temperature detection part 35 detects a temperature less than the target range (tR), the control device 8 sets a value obtained by adding the predetermined correction amount (h) to the target temperature (tC) as the corrected target temperature (tC). The corrected target temperature (tC) is temporarily stored in the memory of the control device 8.

The predetermined correction amount (h) is a value that can be subtracted from or added to the target temperature (tC) to bring the temperature of the fixing belt 20 that is outside the target range (tR) back within the target range (tR), and is experimentally determined and stored (saved) in the memory of the control device 8 in advance. The control device 8 controls and executed the correction process S20 to achieve the correction control.

In the second heater temperature determination process S21, the control device 8 compares the detection signal (the temperature of the heater 22) transmitted from the heater temperature detection part 36 with the corrected target temperature (tC). If the temperature of the heater 22 is less than the corrected target temperature (tC) (NO in S21), the control device 8 executes the second heater heating process S23 for supplying the power to the heater 22 while controlling the power source 18. On the other hand, if the temperature of the heater 22 is equal to or higher than the corrected target temperature (tC) (YES in S21), the control device 8 executes the second belt temperature determination process S22.

In the second belt temperature determination process S22, the control device 8 determines whether the detection signal (the temperature of the fixing belt 20) transmitted from the belt temperature detection part 35 is outside the target range (tR). If the temperature of the fixing belt 20 is within the target range (tR) (NO in S22), the control device 8 executes the second heater heating process S23. On the other hand, if the temperature of the fixing belt 20 is outside the target range (tR) (YES in S22), the control device 8 executes the correction process S20 again. When the image forming process (fixing process) ends, the power control method (the correction control and the second power supply control) of the heater 22 also ends.

The second heater temperature determination process S21, the second belt temperature determination process S22, and the second heater heating process S23 described above are executed and controlled by the control device 8 to achieve the second power supply control. In the second power supply control, the power is supplied to the heater 22 so as to detect the corrected target temperature (tC) by the heater temperature detection part 36. The control device 8 repeatedly executes the correction control (the correction process S20) and the second power supply control (processes S20 to S23) in a second control cycle (T2) (for example, 1 second intervals) which is longer than the first control cycle (T1). The second control cycle (T2) is set at a time interval of not less than 10 times the first control cycle (T1). Preferably, the second control cycle (T2) is set at a time interval of 10 times or more and 50 times or less the first control cycle (T1).

### Verification

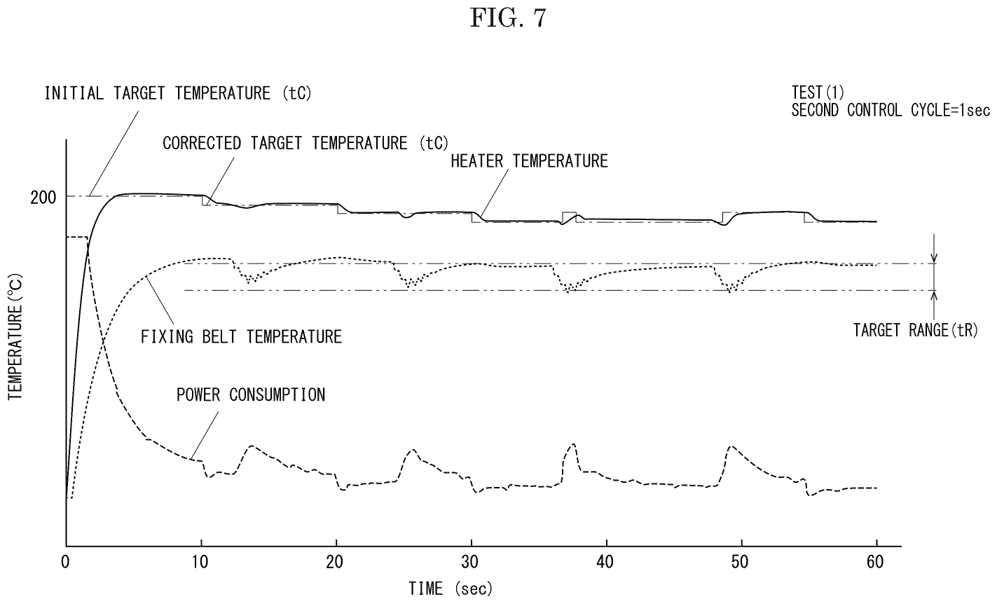

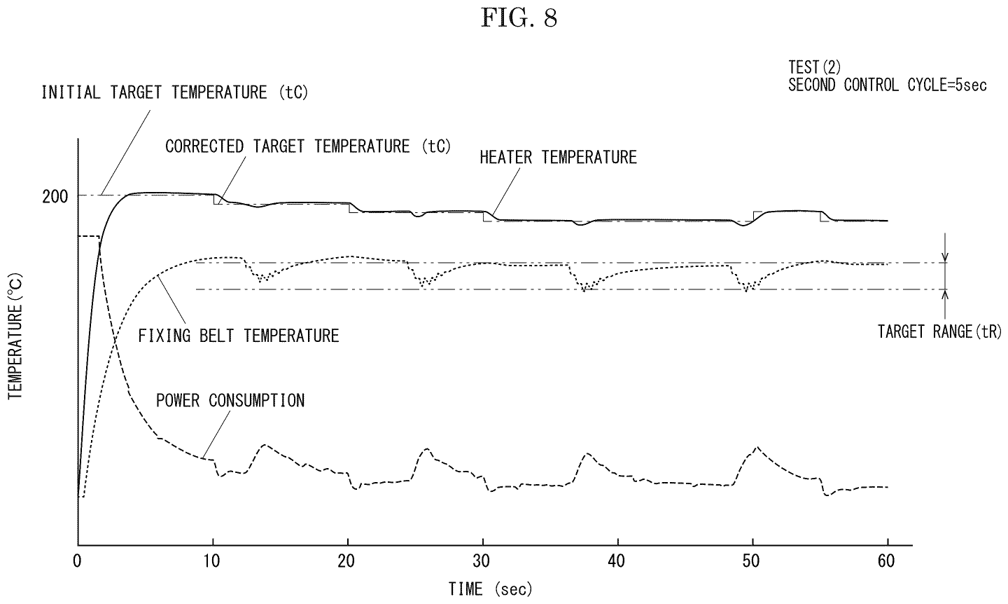

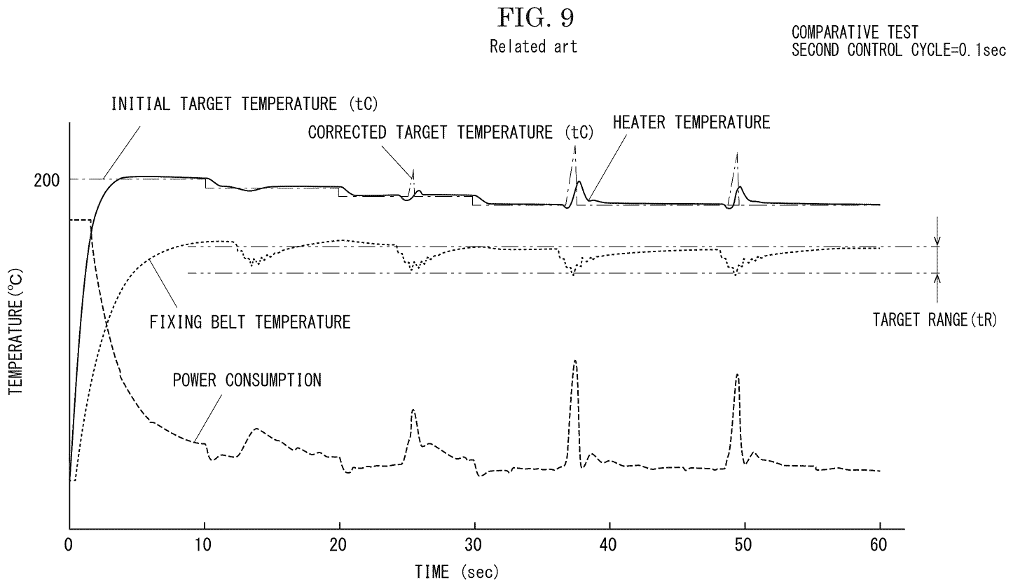

The applicant carried out a test (verification) to confirm the effectiveness of the power control method of the fixing device 7 and the heater 22 according to this embodiment. The test (verification) of the fixing device 7 and the power control method will be described below with reference to FIG. 7 to FIG. 9. FIG. 7 to FIG. 9 are graphs showing changes in temperature and power of the heater 22 with time, FIG. 7 is a test result of a test (1), FIG. 8 is a test result of a test (2), and FIG. 9 is a test result of a comparative test.

In this verification, three tests with different second control cycle (T2) were carried out. Specifically, the tests (1) and (2) using the power control method of the heater 22 according to the present embodiment and a comparative test not using the power control method were carried out.

The conditions common to all three tests will be described. In each of the three tests, the image forming operation (fixing operation) was performed for about 60 seconds using the image forming apparatus 1 (the fixing device 7) according to the present embodiment, the followings [1] to [3] were measured during the performing of the operation, and the measurement results were graphed.
[1] A temperature of the heater 22 (detection result of the heater temperature detection part 36).
[2] A temperature of the fixing belt 20 (detection result of the belt temperature detection part 35).
[3] A power supplied to the heater 22 (power consumption).

In each of the three tests, the initial target temperature (tC) was set to 200 degrees Celsius and the first control cycle (T1) was set to 0.1 seconds.

### <Comparative Test>

First, the comparative test will be described with reference to FIG. 9. In the comparative test, the second control cycle (T2) was set to 0.1 seconds, which was the same as the first control cycle (T1). That is, in the comparative test, the second control cycle (T2) was set at a time interval less than 10 times that of the first control cycle (T1).

It is presumed that the power supply process S1 (the first power supply control) is being executed until about 10 seconds after the start of the test (start of the power supply to the heater 22). It is presumed that the first correction process S20 (the correction control) was executed after about 10 seconds from the start of the test, and the process was shifted from the power supply process S1 (the first power supply control) to the correction power supply process S2 (the second power supply control). Since the target temperature (tC) (the temperature of the heater 22) was changed gradually after 10 seconds, it is presumed that the correction process S20 (the correction control) was executed a plurality of times in response to the temperature change of the fixing belt 20.

It was confirmed that the temperature of the fixing belt 20 was generally within the target range (tR), although there were times when the temperature was outside the target range (tR). However, since the temperature of the fixing belt 20 fell slightly less than the lower limit of the target range (tR) after about 25 seconds, about 37 seconds, and about 49 seconds from the start of the test, the correction to rapidly increase the target temperature (tC) was made. Since the corrected target temperature (tC) is higher than the initial target temperature (tC), the temperature of the heater 22 rapidly rose. After the target temperature (tC) rapidly rose, the correction to rapidly decrease the target temperature (tC) was made, and the temperature of the heater 22 also rapidly fell. It is presumed that this phenomenon was caused by the fact that since the time interval of the second control cycle (T2) was too short, the target temperature (tC) was corrected a plurality of times during the period when the temperature of the fixing belt 20 fell or rose. In addition, it was confirmed that the power consumption temporarily increased rapidly in order to make the temperature of the heater 22 follow the corrected target temperature (tC).

As described above, in the comparative test in which the second control cycle (T2) was set to 0.1 seconds, which is the same as the first control cycle (T1), it was confirmed that the target temperature (tC) changed excessively and the temperature of the heater 22 became unstable. It was also confirmed that wasteful power was consumed.

### <Tests (1) and (2)>

Next, the test (1) and the test (2) will be described with reference to FIG. 7 and FIG. 8. In the test (1), the second control cycle (T2) was set to 1 second, which is 10 times the first control cycle (T1), and in the test (2), the second control cycle (T2) was set to 5 seconds, which is 50 times the first control cycle (T1). That is, in the tests (1) and (2), the second control cycle (T2) was set at a time interval of 10 times or more and 50 times or less the first control cycle (T1).

As in the comparative test (see FIG. 9) described above, it is presumed that the power supply process S1 (the first power supply control) was executed until about 10 seconds after the start of the test, and the first correction process S20 (the correction control) was executed at about 10 seconds, and the process was shifted from the power supply process S1 (the first power supply control) to the correction power supply process S2 (the second power supply control). Since the target temperature (tC) (the temperature of the heater 22) was changed gradually after 10 seconds, it is presumed that the correction process S20 (the correction control) was executed a plurality of times according to the temperature change of the fixing belt 20.

It was confirmed that the temperature of the fixing belt 20 was generally within the target range (tR), although there were times when the temperature was outside the target range (tR). The target temperature (tC) was gradually decreased from the start of the test until about 30 seconds, and then gradually increased or decreased after 30 seconds. However, in the tests (1) and (2), the correction to rapidly increase or decrease the target temperature (tC), which was confirmed in the comparative test (see FIG. 9), was not confirmed. In addition, the tests (1) and (2) did not show a temporary increase in power consumption, which was confirmed in the comparative test (see FIG. 9).

As described above, it was confirmed that in the tests (1) and (2) in which the second control cycle (T2) was set to 10 times or more and 50 times or less the first control cycle (T1), excessive change in the target temperature (tC) was suppressed and the temperature of the heater 22 was stabilized. It was also confirmed that wasteful power consumption was suppressed. That is, the effectiveness of the power control method of the fixing device 7 and the heater 22 according to this embodiment was confirmed by this verification.

In the fixing device 7 (the power control method of the heater 22) according to the present embodiment described above, the first power supply control to the heater 22 is executed in the first control cycle (T1) until the temperature of the heater 22 reaches the target temperature (tC) and the temperature of the fixing belt 20 falls outside the target range (tR). Thereafter, when the temperature of the fixing belt 20 is outside the target range (tR), the correction control for correcting the target temperature (tC) in order to return the temperature within the target range (tR) and the second power supply control for bringing the temperature of the heater 22 to the corrected target temperature (tC) are executed in the second control cycle (T2). The second control period (T2) is set at a time interval of 10 times or more the first control period (T1). According to this configuration, the target temperature (tC) of the heater 22 is corrected so as to maintain the temperature of the fixing belt 20 within the target range (tR), and the heater 22 can be controlled at the corrected target temperature (tC). Since the second control cycle (T2) is longer than the first control cycle (T1), the target temperature (tC) of the heater 22 can be corrected (changed) after the temperature of the fixing belt 20 is changed. Thus, the heater 22 can be maintained at the target temperature (tC) and the fixing belt 20 can be maintained at a temperature within the target range (tR) while absorbing a timing difference (time lag) of temperature changes between the heater 22 and the fixing belt 20.

Further, according to the fixing device 7 (the power control method of the heater 22) according to the present embodiment, the heater 22 and the fixing belt 20 can be maintained at the predetermined temperatures, and since excessive temperature rise of the heater 22 is prevented, it is possible to suppress failure or the like of the components (for example, the heater temperature detection part 36, and the others) around the heater 22. Further, since the temperature change of the fixing belt 20 is kept within a certain range, the temperature in the pressure region N is stabilized, and the proper fixing processing can be ensured. As a result, the image quality of the fixed image can be improved. Further, since the excessive power supply to the heater 22 is prevented, power saving can be achieved.

In the fixing device 7 according to the present embodiment, the control device 8 (the power control part) changes (increases or decreases) the target temperature (tC) by the predetermined correction amount (h) when the belt temperature detection part 35 detects a temperature outside the target range (tR). According to this configuration, the target temperature (tC) for returning the temperature of the fixing belt 20 to the target range (tR) can be quickly calculated by a simple calculation. As a result, the target temperature (tC) can be corrected even with the inexpensive control device 8 having a low calculation speed, so that the manufacturing cost of the fixing device 7 can be reduced.

In the fixing device 7 according to the present embodiment, one belt temperature detection part 35 and one heater temperature detection part 36 are provided, but two or more of them may be provided (not shown). Further, although the belt temperature detection part 35 and the heater temperature detection part 36 are the thermistors, they are not limited thereto and may be other temperature sensors such as thermocouples or temperature measuring resistors. Further, although the belt temperature detection part 35 is in contact with the inner surface of the fixing belt 20, it is not limited thereto, and may be in contact with the outer surface of the fixing belt 20 in the non-passing region A2 (not shown). Alternatively, the belt temperature detection part 35 may be a non-contact temperature measurement device such as an infrared radiation thermometer, and may be provided in a non-contact manner with the inner or outer surface of the fixing belt 20 (not shown). Further, although the heater temperature detection part 36 is in contact with the upper surface of the substrate 30 of the heater 22, it is not limited thereto, but may be in contact with, for example, the lower surface of the substrate 30, or may be in contact with the upper surface of the heat equalizing member when the heat equalizing member is provided on the substrate 30 (both of which are not shown).

In the fixing device 7 (the power control method of the heater 22) according to the present embodiment, the second control cycle (T2), which is the execution cycle of the correction control and the second power supply control, may be set at a time interval 10 times or more the first control cycle (T1), which is the execution cycle of the first power supply control. The lower limit of the magnification in the second control cycle (T2) is 10 times, but the upper limit of the magnification in the second control cycle (T2) is not particularly limited, and may be set experimentally based on, for example, a difference in heat capacity between the heater 22 and the fixing belt 20, a difference in temperature rise speed (time lag), or the like. The applicant has confirmed by the test (verification) that the heater 22 and the fixing belt 20 can be effectively maintained at the predetermined temperatures by setting the second control cycle (T2) at a time interval of 10 times or more and 50 times or less the first control cycle (T1).

Further, in the fixing device 7 according to the present embodiment, although the heat generating part 31 is divided into three resistance heating elements 32A to 32C, it is not limited to this, but may be divided into two, four or more, or not (none of which is shown). In addition, the heat generating part 31 may be a single resistance heating element extending from one end to the other end in the axial direction, or may be a U-shaped resistance heating element extending from one axial end to the other axial end, and then folded back to extend from the other axial end to one axial end (not shown).

In the fixing device 7 according to the present embodiment, the paper P passes through the center of the pressure region N in the axial direction, but the paper P may pass through a position closer to one end side of the pressure region N in the axial direction (not shown). In this case, the non-passing region A2 is set only on one side in the axial direction of the fixing belt 20 (or the pressure region N).

In the fixing device 7 according to the present embodiment, although the pressure roller 21 is rotationally driven and the fixing belt 20 is driven to be rotated, the fixing belt 20 may be rotationally driven and the pressure roller 21 may be driven to be rotated.

In the description of the above-described embodiment, the present disclosure is applied to the monochrome image forming apparatus 1 as an example, but the present disclosure is not limited thereto, and the present disclosure may be applied to, for example, a color printer, a copying machine, a facsimile machine, or a multifunctional peripheral.

It should be noted that the description of the above embodiments shows one aspect of the fixing device and the image forming apparatus according to the present disclosure, and the technical range of the present disclosure is not limited to the above embodiments. The present disclosure may be varied, replaced, and modified without departing from the spirit of the technical thought, and the scope of the claims includes all embodiments that may be included within the scope of the technical thought.

1. A fixing device comprising:
a fixing belt which is in a cylindrical shape and heats toner on a medium while rotating around an axis;
a pressure member which forms a pressure region between the fixing belt and the pressure member, and pressurizes the toner on the medium passing through the pressure region while rotating around an axis;
a heater which comes into contact with an inner surface of the fixing belt facing the pressure region, receives electric power, generates heat, and heats the fixing belt;
a belt temperature detection part which detects a temperature of the fixing belt;
a heater temperature detection part which detects a temperature of the heater; and
a power control part which controls power supplied to the heater, wherein
the power control part executes a first power supply control for supply power to the heater, in a first control cycle until the heater temperature detection part detects a target temperature and the belt temperature detection part detects a temperature outside a target range,
when the belt temperature detection part detects a temperature outside the target range, the power control part executes a correction control for correcting the target temperature so that the belt temperature detection part detects a temperature within the target range, and a second power supply control for supplying power to the heater so that the heater temperature detection part detects a corrected target temperature, in a second control cycle set at a time interval 10 times or more the first control cycle.

2. The fixing device according to claim 1, wherein
when the belt temperature detection part detects a temperature higher than the target range, the power control part sets a value obtained by subtracting a predetermined correction amount from the target temperature as the corrected target temperature, and
when the belt temperature detection part detects a temperature less than the target range, the power control part sets a value obtained by adding a predetermined correction amount to the target temperature as the corrected target temperature.

3. The fixing device according to claim 1, wherein
the second control cycle is set at a time interval 10 times or more and 50 times or less the first control period.

4. An image forming apparatus, comprising the fixing device according to claim 1.

5. A method for controlling power of a heater provided in the fixing device according to claims 1, the method comprising:
a power supply process for executing the first power supply control for supplying power to the heater in the first control cycle until the heater temperature detection part detects the target temperature and the belt temperature detection part detects a temperature outside the target range; and
a correction power supply process for executing the correction control and the second power supply control in the second control cycle, the correction control for correcting the target temperature so that the belt temperature detection part detects a temperature within the target range when the belt temperature detection part detects a temperature outside the target range; and the second power supply control for supplying power to the heater so that the heater temperature detection part detects the corrected target temperature.
